(19) United States
(12) Patent Application Publication
(10) Pub. No.: US 2011/0018662 A1
(43) Pub. Date: Jan. 27, 2011

(54) METHOD OF USING A DIAMAGNETIC MATERIALS FOR FOCUSING MAGNETIC FIELD LINES

(75) Inventors: Georg DEGEN, Lorsch (DE); Fabian SEELER, Dossenheim (DE)

Correspondence Address: OBLON, SPIVAK, MCCLELLAND MAIER & NEUSTADT, L.L.P., 1940 DUKE STREET, ALEXANDRIA, VA, 22314, US

(73) Assignee: BASF SE, Ludwigshafen (DE)

(21) Appl. No.: 12/831,524

(22) Filed: Jul. 7, 2010

(30) Foreign Application Priority Data
Jul. 23, 2009 (EP) 09166175.1

(51) Int. Cl. H01F 7/00

(52) U.S. Cl. 335/301

(57) ABSTRACT

The use of diamagnetic materials in a magnetic field, into which a paramagnetic material is introduced, as a focuser for focusing the magnetic field lines in the paramagnetic material is described.

The invention relates to the use of diamagnetic materials for focusing magnetic field lines, and to shaped bodies composed of magnetocaloric materials for coolers, heat pumps or generators, which comprise diamagnetic materials.

To generate strong magnetic fields, costly magnetic materials such as NdFeB magnets are frequently used. To save costs and materials, the magnets are designed such that a maximum magnetic field can be generated with a minimum amount of magnetic material. Frequently, ferromagnetic materials are used to amplify the field lines in a particular region of the magnetic field. However, such ferromagnetic materials can be used viably only where the magnetic field should not act on other materials, since they, owing to their ferromagnetic properties, focus the field lines away from these materials and toward themselves.

It is an object of the present invention to provide materials or devices for focusing the magnetic field lines of a directed magnetic field onto the region in which such an amplification is required.

The object is achieved in accordance with the invention by the use of diamagnetic materials in a magnetic field into which a paramagnetic material is introduced as a focuser for focusing the magnetic field lines in the paramagnetic material.

In addition, the object is achieved in accordance with the invention by a shaped body composed of magnetocaloric material for coolers, heat pumps or generators, which has channels for passing a heat carrier medium through and a form suitable for introduction into a magnetic field, wherein the shaped body is at least partly surrounded by a diamagnetic material at the surfaces which run essentially parallel to the magnetic field lines.

In addition, the object is achieved in accordance with the invention by a shaped body composed of magnetocaloric material for coolers, heat pumps or generators, which has channels for passing a heat carrier medium through and a form suitable for introduction into a magnetic field, wherein the shaped body has inclusions of diamagnetic material running in the direction of the magnetic field lines.

Materials which have the property of moving from sites of high field strength to sites of lower field strength in an inhomogeneous magnetic field are referred to as diamagnetics or diamagnetic materials. Substances with converse behavior, specifically the tendency to migrate into a stronger field, are referred to as paramagnetic. Diamagnetism is caused by the interaction between magnetic fields and moving charged particles, especially electrons. In terms of magnitude, it is small compared to paramagnetism. Paramagnetism, on the other hand, is caused by spin momentum and orbital angular momentum of the electrons. Diamagnetic substances are all of those whose atoms or molecules occupy closed electron shells, since, in this case, the magnetic individual moments of the electrons eliminate one another, and hence no magnetic overall moment appears externally. The diamagnetic substances include, for example, all noble gases and all substances with noble gas-like ions or atoms. These include, for example, most organic compounds. Diamagnetic materials whose use is preferred in accordance with the invention are plastics, wood, metal oxides, ceramic, leather, textiles or mixtures thereof. Plastics are preferably selected from polyethylene, polypropylene, polyurethane, polyamide, polystyrene, polyester, polymethyl methacrylate, polyethylene terephthalate, polybutylene terephthalate, polycarbonate, polyimide, polyacetal, polyphenylene ether, polyvinyl acetate, polyvinyl chloride and mixtures thereof.

A magnetic field which has already been amplified by the customary methods of magnet design, for example by the concentration of the magnetic field by ferromagnetic shoes, can additionally be amplified by use of diamagnetic materials in the regions in which the magnetic field is not required, or in a region which surrounds the region of the magnetic field. The field lines are repelled by the diamagnetic material and deflected into the region beside the material. There is thus an amplification of the field outside the diamagnetic material, and hence within the region in which the field is required. If, for example, a material A is to be introduced into a magnetic field in order to exert a physical effect, it is advantageous to surround this material A with a diamagnetic material B in order to concentrate the magnetic field lines within the material A. In one embodiment of the invention, it may also be advisable also to introduce a diamagnetic material into the magnetic field in order to even more strongly concentrate the field lines to the region in which a high field strength is required. The alignment of the diamagnetic materials parallel to the magnetic field lines is particularly advantageous.

According to the invention, a diamagnetic material is thus used in combination with a paramagnetic material, as a result of which the magnetic field lines are deflected or focused into the paramagnetic material, or focused therein.

In this case, the paramagnetic material may be surrounded by the diamagnetic material essentially along or parallel to the magnetic field lines. When the starting point is a cuboidal paramagnetic material which is introduced vertically into a magnetic field, the cuboid may, for example, be surrounded by the diamagnetic material on four faces, while the faces facing the magnetic poles, with respect to which the magnetic field lines are vertical or essentially vertical, are not covered by the diamagnetic material. The term “essentially” along or parallel to the magnetic field lines permits angle deviations of ±10°, preferably ±5°, especially ±2°.

In another embodiment of the invention, the paramagnetic material may comprise inclusions of the diamagnetic material essentially along the magnetic field lines. These inclusions may be present in the form of rods which permeate the paramagnetic material parallel to the magnetic field lines. These rods may have a round, angular, polygonal, oval or other cross section and permeate the paramagnetic shaped body preferably in straight, parallel lines. The rods may be distributed homogeneously spaced apart in the paramagnetic material.

In one embodiment of the invention, the space into which a paramagnetic material is introduced in a magnetic field is surrounded by a diamagnetic material essentially along or parallel to the magnetic field lines. This enables very substantially all magnetic field lines to run through the paramagnetic material.

An opposite effect would be brought about if a paramagnetic, ferromagnetic or antiferromagnetic material were to be used to surround the region of the highest desired field strength or to divide it into subregions.

The paramagnetic material is preferably a magnetocaloric material.

Such materials are known in principle and are described, for example, in WO 2004/068512. In a material which exhibits a magnetocaloric effect, the alignment of randomly aligned magnetic moments by an external magnetic field leads to heating of the material. This heat can be removed from the MCE material to the surrounding atmosphere by heat transfer. When the magnetic field is then switched off or removed, the magnetic moments revert back to a random arrangement, which leads to cooling of the material below ambient temperature. This effect can be exploited for cooling purposes; see also Nature, vol. 415, Jan. 10, 2002, pages 150 to 152. Typically, a heat transfer medium such as water is used for heat removal from the magnetocaloric material. Accordingly, applications as heat pumps and generators are available.

Typical materials for magnetic cooling are multimetal materials which often comprise at least three metallic elements and additionally optionally nonmetallic elements. The expression “metal-based materials” indicates that the predominant proportion of these materials is formed from metals or metallic elements. Typically, the proportion in the overall material is at least 50% by weight, preferably at least 75% by weight, especially at least 80% by weight. Suitable metal-based materials are explained in detail below.

The magnetocaloric or metal-based material is more preferably selected from

(1) compounds of the general formula (I)

(A_{y}B_{y-1})_{2+δ}C_{w}DₓE_{z} (I)
where
A is Mn or Co,
B is Fe, Cr or Ni,
C, D, E at least two of C, D, and E are different than one another, have a non-vanishing concentration and are selected from P, B, Se, Ge, Ga, Si, Sn, N, As and Sb, where at least one of C, D and E is Ge, As or Si,
δ is in the range from −0.1 to 0.1,
w, x, y, z are each in the range from 0 to 1, where w+x+z=1;

(2) La- and Fe-based compounds of the general formulae (II) and/or (Ill) and/or (IV)

Le(FeₓAl₁₋ₓ)₁₃H_{y} or La(FeₓSi₁₋ₓ)₁₃H_{y} (II)
where
x is from 0.7 to 0.95,
y is from 0 to 3, preferably from 0 to 2;

La(FeₓAl_{y}Co_{z})₁₃ or La(FeₓSi_{y}Co_{z})₁₃ (III)
where
x is from 0.7 to 0.95,
y is from 0.05 to 1−x
z is from 0.005 to 0.5;

LaMnₓFe₂₋ₓGe (IV)
where
x is from 1.7 to 1.95, and

(3) Heusler alloys of the MnTP type where T is a transition metal and P is a p-doping metal with an electron count per atom e/a in the range from 7 to 8.5.

Materials particularly suitable in accordance with the invention are described, for example, in WO 2004/068512, Rare Metals, vol. 25, 2006, pages 544 to 549, J. Appl. Phys. 99,08Q107 (2006), Nature, Vol. 415, Jan. 10, 2002, pages 150 to 152 and Physica B 327 (2003), pages 431 to 437.

In the aforementioned compounds of the general formula (I), C, D and E are preferably identical or different and are selected from at least one of P, Ge, Si, Sn and Ga.

The metal-based material of the general formula (I) is preferably selected from at least quaternary compounds which, as well as Mn, Fe, P and optionally Sb, additionally comprise Ge or Si or As or Ge and Si or Ge and As or Si and As or Ge, Si and As.

Preferably at least 90% by weight, more preferably at least 95% by weight, of component A is Mn. Preferably at least 90% by weight, more preferably at least 95% by weight, of B is Fe. Preferably at least 90% by weight, more preferably at least 95% by weight, of C is P. Preferably at least 90% by weight, more preferably at least 95% by weight, of D is Ge. Preferably at least 90% by weight, more preferably at least 95% by weight, of E is Si. The material preferably has the general formula MnFe(P,Ge.Si_{z}).

x is preferably in the range from 0.3 to 0.7, w is less than or equal to 1−x and z corresponds to 1−x−w.

The material preferably has the crystalline hexagonal Fe₂P structure. Examples of suitable structures are MnFeP_{0.45 to 0.7}, Ge_{0.55 to 0.30} and MnFeP_{0.5 to 0.70}, (Si/Ge)_{0.5 to 0.30}.

Suitable compounds are also Mₙ₁₊ₓFe₁₌ₓGe_{y} where x is in the range from −0.3 to 0.5, y is in the range from 0.1 to 0.6. Likewise suitable are compounds of the general formula Mn₁₊ₓFe₁₋ₓP_{1-y}Ge_{y-z}Sb_{z} where x is in the range from −0.3 to 0.5, y is in the range from 0.1 to 0.6 and z is less than y and less than 0.2. Additionally suitable are compounds of the formula Mn₁₊xFe₁₋ₓP_{1-y}Ge_{y-z}Si_{z} where x is in the range from 0.3 to 0.5, y is in the range from 0.1 to 0.66, z is less than or equal to y and less than 0.6.

Preferred La- and Fe-based compounds of the general formulae (II) and/or (III) and/or (IV) are La(Fe_{0.90}Si_{0.10})₁₃, La(Fe_{0.89}Si_{0.11})₁₃, La(Fe_{0.880}Si_{0.120})₁₃, La(Fe_{0.877}Si_{0.123})₁₃, LaFe_{11.8}Si_{1.2}, La(Fe_{0.88}Si_{0.12})₁₃H_{0.5}, La(Fe_{0.88}Si_{0.12})₁₃H_{1.0}, LaFe_{11.7}S_{1.3}H_{1.1}, LaFe_{11.57}Si_{1.43}H_{1.3}, La(Fe_{0.88}Si_{0.12})H_{1.5}, LaFe_{11.2}Co_{0.7}Si_{1.1}, LaFe_{11.5}Al_{1.5}C_{0.1}, LaFe_{11.5}Al_{1.5}C_{0.2}, LaFe_{11.5}Al_{1.5}C_{0.4}, LaFe_{11.5}Al_{1.5}Co_{0.5}, La(Fe_{0.94}Co_{0.06})_{11.83}Al_{1.17}, La(Fe_{0.92}Co_{0.08})_{11.83}Al_{1.17}.

Suitable manganese-comprising compounds are MnFeGe, MnFe_{0.9}Co_{0.1}Ge, MnFe_{0.8}Co_{0.2}Ge, MnFe_{0.7}Co_{0.3}Ge, MnFe_{0.6}Co_{0.4}Ge, MnFe_{0.6}Co_{0.6}Ge, MnFe_{0.4}Co_{0.6}Ge, MnFe_{0.3}Co_{0.7}Ge, MnFe_{0.2}Co_{0.8}Ge, MnFe_{0.15}Co_{0.85}Ge, MnFe_{0.1}Co_{0.9}Ge, MnCoGe, Mn₅Ge_{2.5}Si_{0.5}, Mn₅Ge₂Si, Mn₅Ge_{1.5}Si_{1.5}, Mn₅GeSi₂, Mn₅Ge₃, Mn₅Ge_{2.9}Sb_{0.1}, Mn₅Ge_{2.8}Sb_{0.2}, Mn₅Ge_{2.7}Sb_{0.3}, LaMn_{1.9}Fe_{0.1}Ge, LaMn_{1.86}Fe_{0.15}Ge, LaMn_{1.8}Fe_{0.2}Ge, (Fe_{0.9}Mn_{0.1})₃C, (Fe_{0.8}Mn_{0.2})₃C, (Fe_{0.7}Mn_{0.3})₃C, Mn₃GaC, MnAs, (Mn, Fe)As, Mn_{1+δ}As_{0.8}Sb_{0.2}, MnAs_{0.75}Sb_{0.25}, Mn_{1.1}As_{0.75}Sb_{0.25}, Mn_{1.5}As_{0.75}Sb_{0.25}.

Heusler alloys suitable in accordance with the invention are, for example, Fe₂MnSi_{0.5}Ge_{0.5}, Ni_{52.9}Mn_{22.4}Ga_{24.7}, Ni_{50.9}Mn_{24.7}Ga_{24.4}, Ni_{55.2}Mn_{18.6}Ga_{26.2}, Ni_{51.6}Mn_{24.7}Ga_{23.8}, Ni_{52.7}Mn_{23.9}Ga_{23.4}, CoMnSb, CoNb_{0.2}Mn_{0.8}Sb, CoNb_{0.4}Mn_{0.6}SB, CoNb_{0.6}Mn_{0.4}Sb, Ni₅₀Mn₃₅Sn_{15, Ni}₅₀Mn₃₇Sn₁₃, MnFeP_{0.45}As_{0.55}, MnFeP_{0.47}As_{0.53}, Mn_{1.1}Fe_{0.9}P_{0.47}As_{0.53}, MnFeP_{0.89-χ}Si_{χ}Ge_{0.11}, χ=0.22, χ=0.26, χ=0.30, χ=0.33.

The average crystal size is generally in the range from 10 to 400 nm, more preferably 20 to 200 nm, especially 30 to 80 nm. The average crystal size can be determined by x-ray diffraction. When the crystal size is too small, the maximum magnetocaloric effect is reduced. When the crystal size, in contrast, is too large, the hysteresis of the system rises.

Customary materials are produced by solid phase reaction of the starting elements or starting alloys for the material in a ball mill, subsequent pressing, sintering and heat treatment under inert gas atmosphere and subsequent slow cooling to room temperature.

Processing via melt spinning is also possible. This makes possible a more homogeneous element distribution which leads to an improved magnetocaloric effect. In the process described there, the starting elements are first induction-melted in an argon gas atmosphere and then sprayed in the molten state through a nozzle onto a rotating copper roller. There follows sintering at 1000° C. and slow cooling to room temperature.

The preparation of the metal-based materials for magnetic cooling or heat pumps or generators comprises, for example, the following steps:
a) reacting chemical elements and/or alloys in a stoichiometry which corresponds to the metal-based material in the solid and/or liquid phase,
b) if appropriate converting the reaction product from stage a) to a solid,
c) sintering and/or heat treating the solid from stage a) or b),
d) quenching the sintered and/or heat-treated solid from stage c) at a cooling rate of at least 100 K/s.

The quenching can be achieved by any suitable cooling processes, for example by quenching the solid with water or aqueous liquids, for example cooled water or ice/water mixtures. The solids can, for example, be allowed to fall into ice-cooled water. It is also possible to quench the solids with subcooled gases such as liquid nitrogen. Further processes for quenching are known to those skilled in the art. What is advantageous here is controlled and rapid cooling.

In step (a) of the process according to the invention, the elements and/or alloys which are present in the later metal-based material are converted in a stoichiometry which corresponds to the metal-based material in the solid or liquid phase.

Preference is given to performing the reaction in stage a) by combined heating of the elements and/or alloys in a closed vessel or in an extruder, or by solid phase reaction in a ball mill. Particular preference is given to performing a solid phase reaction, which is effected especially in a ball mill. Such a reaction is known in principle; cf. the documents cited by way of introduction. Typically, powders of the individual elements or powders of alloys of two or more of the individual elements which are present in the later metal-based material are mixed in pulverulent form in suitable proportions by weight. If necessary, the mixture can additionally be ground in order to obtain a microcrystalline powder mixture. This powder mixture is preferably heated in a ball mill, which leads to further comminution and also good mixing, and to a solid phase reaction in the powder mixture.

Alternatively, the individual elements are mixed as a powder in the selected stoichiometry and then melted.

The combined heating in a closed vessel allows the fixing of volatile elements and control of the stoichiometry. Specifically in the case of use of phosphorus, this would evaporate easily in an open system.

The reaction is followed by sintering and/or heat treatment of the solid, for which one or more intermediate steps can be provided. For example, the solid obtained in stage a) can be pressed before it is sintered and/or heat treated. This increases the density of the material, such that a high density of the magnetocaloric material is present in the later application. This is advantageous especially because the volume within which the magnetic field exists can be reduced, which may be associated with considerable cost savings. Pressing is known per se and can be carried out with or without pressing aids.

It is possible to use any suitable mold for this pressing. By virtue of the pressing, it is already possible to obtain shaped bodies in the desired three-dimensional structure. The pressing may be followed by the sintering and/or heat treatment of stage c), followed by the quenching of stage d).

Alternatively, it is possible to send the solid obtained from the ball mill to a melt-spinning process. Melt-spinning processes are known per se and are described, for example, in Rare Metals, vol. 25, October 2006, pages 544 to 549, and also in WO 2004/068512.

In these processes, the composition obtained in stage a) is melted and sprayed onto a rotating cold metal roller. This spraying can be achieved by means of elevated pressure upstream of the spray nozzle or reduced pressure downstream of the spray nozzle. Typically, a rotating copper drum or roller is used, which can additionally be cooled if appropriate. The copper drum preferably rotates at a surface speed of from 10 to 40 m/s, especially from 20 to 30 m/s. On the copper drum, the liquid composition is cooled at a rate of preferably from 10² to 10⁷ K/s, more preferably at a rate of at least 10⁴ K/s, especially at a rate of from 0.5 to 2×10⁶ K/s.

The melt-spinning, like the reaction in stage a) too, can be performed under reduced pressure or under an inert gas atmosphere.

The melt spinning achieves a high processing rate, since the subsequent sintering and heat treatment can be shortened. Specifically on the industrial scale, the production of the metal-based materials thus becomes significantly more economically viable. Spray-drying also leads to a high processing rate. Particular preference is given to performing melt spinning.

Alternatively, in stage b), spray cooling can be carried out, in which a melt of the composition from stage a) is sprayed into a spray tower. The spray tower may, for example, additionally be cooled. In spray towers, cooling rates in the range from 10³ to 10⁵ K/s, especially about 10⁴ K/s, are frequently achieved.

The sintering and/or heat treatment of the solid is effected in stage c) preferably first at a temperature in the range from 800 to 1400° C. for sintering and then at a temperature in the range from 500 to 750° C. for heat treatment. These values apply especially to shaped bodies, whereas lower sintering and heat treatment temperatures can be employed for powders. For example, the sintering can then be effected at a temperature in the range from 500 to 800° C. For shaped bodies/solids, the sintering is more preferably effected at a temperature in the range from 1000 to 1300° C., especially from 1100 to 1300° C. The heat treatment can then be effected, for example, at from 600 to 700° C.

The sintering is performed preferably for a period of from 1 to 50 hours, more preferably from 2 to 20 hours, especially from 5 to 15 hours. The heat treatment is performed preferably for a period in the range from 10 to 100 hours, more preferably from 10 to 60 hours, especially from 30 to 50 hours. The exact periods can be adjusted to the practical requirements according to the material.

In the case of use of the melt-spinning process, it is frequently possible to dispense with sintering, and the heat treatment can be shortened significantly, for example to periods of from 5 minutes to 5 hours, preferably from 10 minutes to 1 hour. Compared to the otherwise customary values of 10 hours for sintering and 50 hours for heat treatment, this results in a major time advantage.

The sintering/heat treatment results in partial melting of the particle boundaries, such that the material is compacted further.

The inventive metal-based materials are preferably used in magnetic cooling as described above. A corresponding refrigerator has, in addition to a magnet, preferably permanent magnet, metal-based materials as described above. The cooling of computer chips and solar power generators is also an option. Further fields of use are heat pumps and air conditioning systems, and also generators.

When the magnetocaloric materials are introduced into a magnetic field, it is desirable to concentrate the magnetic field onto the regions in which the magnetocaloric material is present. The magnetocaloric materials may therefore, in accordance with the invention, be surrounded by a diamagnetic material (with the exception of the end sides which are at right angles to the magnetic field lines). It is also possible, for example, to introduce rods of diamagnetic material into corresponding longitudinal bores in the magnetocaloric shaped body, such that the rods run parallel to the magnetic field lines. This allows the field line density in the magnetocaloric material to be increased.

1. The method of using a diamagnetic materials in a magnetic field into which a paramagnetic material is introduced as a focuser for focusing the magnetic field lines in the paramagnetic material.

2. The method according to claim 1, wherein the paramagnetic material is surrounded by the diamagnetic material essentially parallel to the magnetic field lines.

3. The method according to claim 1, wherein the paramagnetic material comprises inclusions of the diamagnetic material essentially along the magnetic field lines.

4. The method according to claim 1, wherein the space into which a paramagnetic material is introduced in a magnetic field is surrounded by the diamagnetic material essentially parallel to the magnetic field lines.

5. The method according to claim 1, wherein the paramagnetic material is a magnetocaloric material.

6. The method according to claim 5, wherein the magnetocaloric material is selected from (1) compounds of the general formula (I)
(A_{y}B_{y-1})_{2+δ}C_{w}DₓE_{z} (I)
where
A is Mn or Co,
B is Fe, Cr or Ni,
C, D, E at least two of C, D, and E are different from one another, have a non-vanishing concentration and are selected from P, B, Se, Ge, Ga, Si, Sn, N, As and Sb, where at least one of C, D and E is Ge, As or Si,
δ is in the range from −0.1 to 0.1,
w, x, y, z are each in the range from 0 to 1, where w+x+z=1;
(2) La- and Fe-based compounds of the general formulae (II) and/or (III) and/or (IV)
Le(FeₓAl₁₋ₓ)₁₃H_{y} or La(FeₓSi₁₋ₓ)₁₃H_{y} (II)
where
x is from 0.7 to 0.95,
y is from 0 to 3;
La(FeₓAl_{y}Co_{z})₁₃ or La(FeₓSi_{y}Co_{z})₁₃ (III)
where
x is from 0.7 to 0.95,
y is from 0.05 to 1−x
z is from 0.005 to 0.5;
LaMnₓFe₂₋ₓGe (IV)
where
x is from 1.7 to 1.95, and
(3) Heusler alloys of the MnTP type where T is a transition metal and P is a p-doping metal with an electron count per atom e/a in the range from 7 to 8.5.

7. The method according to claim 6, wherein the magnetocaloric material is selected from at least quaternary compounds of the general formula (I) which, as well as Mn, Fe, P and optionally Sb, additionally comprise Ge or Si or As or Ge and As or Si and As, or Ge, Si and As.

8. The method according to claim 1, wherein the diamagnetic material is selected from plastics, wood, metal oxides, ceramic, leather, textiles or mixtures thereof.

9. A shaped body composed of magnetocaloric material for coolers, heat pumps or generators, which has channels for passing a heat carrier medium through and a form suitable for introduction into a magnetic field, wherein the shaped body is at least partly surrounded by a diamagnetic material at the surfaces which run essentially parallel to the magnetic field lines.

10. A shaped body composed of magnetocaloric material for coolers, heat pumps or generators, which has channels for passing a heat carrier medium through and a form suitable for introduction into a magnetic field, wherein the shaped body has inclusions of diamagnetic material running in the direction of the magnetic field lines.
